(19) United States
(12) Patent Application Publication
(10) Pub. No.: US 2015/0194025 A1
(43) Pub. Date: Jul. 9, 2015

(54) INFORMATION PROCESSING APPARATUS, STORE SYSTEM AND METHOD FOR RECOGNIZING OBJECT

(71) Applicant: TOSHIBA TEC KABUSHIKI KAISHA, Tokyo (JP)

(72) Inventor: Youji Tsunoda, Izunokuni Shizuoka (JP)

(21) Appl. No.: 14/589,322

(22) Filed: Jan. 5, 2015

(30) Foreign Application Priority Data
Jan. 8, 2014 (JP) 2014-001543

(51) Int. Cl. G07G 1/00; G06T 7/00; G06Q 20/20; G07G 1/01; G07G 1/12

(52) U.S. Cl. CPC G07G 1/0036; G07G 1/01; G07G 1/12; G06Q 20/208; G06T 7/004; G06T 2207/10004

(57) ABSTRACT

In accordance with one embodiment, an information processing apparatus comprises an image acquisition module, a detection module, a determination module and a display control module. The image acquisition module acquires an image captured by an image capturing section which photographs an object held to the image capturing section. The detection module detects the object contained in the image acquired by the image acquisition module. The determination module determines the propriety of a holding manner of the object detected by the detection module. The display control module controls to display the image and the propriety of the holding manner determined by the determination module on a display section over the image.

### CROSS-REFERENCE TO RELATED APPLICATION

This application is based upon and claims the benefit of priority from Japanese Patent Application No. 2014-001543, filed Jan. 8, 2014, the entire contents of which are incorporated herein by reference.

### FIELD

Embodiments described herein relate generally to an information processing apparatus, a store system and a method for recognizing an object by the information processing apparatus.

### BACKGROUND

Conventionally, there is a general object recognition technology in which feature amount of a target object extracted from image data obtained by photographing the object with an image sensor device is compared with prepared reference data (feature amount) stored in a dictionary to obtain a similarity degree, and the category and the like of the object is recognized (detected) according to the similarity degree. Moreover, a store system in which such a general object recognition technology is applied to the recognition of a commodity such as vegetables and fruits and the sales of the recognized commodity is registered has been proposed.

In the general object recognition described above, the image data obtained by photographing the commodity varies according to the holding manner of the commodity.

Accordingly, there is a possibility that the commodity cannot be recognized and too much time is taken for the commodity registration if the commodity is not held in a suitable manner.

### BRIEF DESCRIPTION OF THE DRAWINGS

FIG. 1 is a perspective view illustrating an example of a checkout system according to one embodiment;

FIG. 2 is a block diagram illustrating the hardware constitution of a POS terminal and a commodity reading apparatus;

FIG. 3 is a conceptual diagram illustrating an example of the data constitution of a PLU file;

FIG. 4 is a block diagram illustrating the functional components of the POS terminal;

FIG. 5 is a flowchart illustrating a holding manner determination processing executed by the checkout system;

FIG. 6 is a diagram illustrating an example of an accuracy check screen on which a frame border indicating a proper holding manner is displayed over a frame image;

FIG. 7 is a diagram illustrating an example of the accuracy check screen on which a frame border indicating an improper holding manner is displayed over a frame image;

FIG. 8 is a diagram illustrating an example of a termination execution screen;

FIG. 9 is a perspective view illustrating the external constitution of the self-checkout POS terminal; and

FIG. 10 is a block diagram illustrating the hardware constitution of the self-checkout POS terminal.

### DETAILED DESCRIPTION

In accordance with one embodiment, an information processing apparatus comprises an image acquisition module, a detection module, a determination module and a display control module. The image acquisition module acquires an image captured by an image capturing section which photographs an object held to the image capturing section. The detection module detects the object contained in the image acquired by the image acquisition module. The determination module determines the propriety of a holding manner of the object detected by the detection module. The display control module controls to display the image and the propriety of the holding manner determined by the determination module on a display section over the image.

Hereinafter, the information processing apparatus, the store system and the object recognition method according to the present embodiment are described with reference to the accompanying drawings by taking a checkout system as an example. The store system is a checkout system (POS system) and the like equipped with a POS terminal for registering commodities and carrying out the settlement in one transaction. The present embodiment is an example of application to a checkout system introduced to a store such as a supermarket and the like.

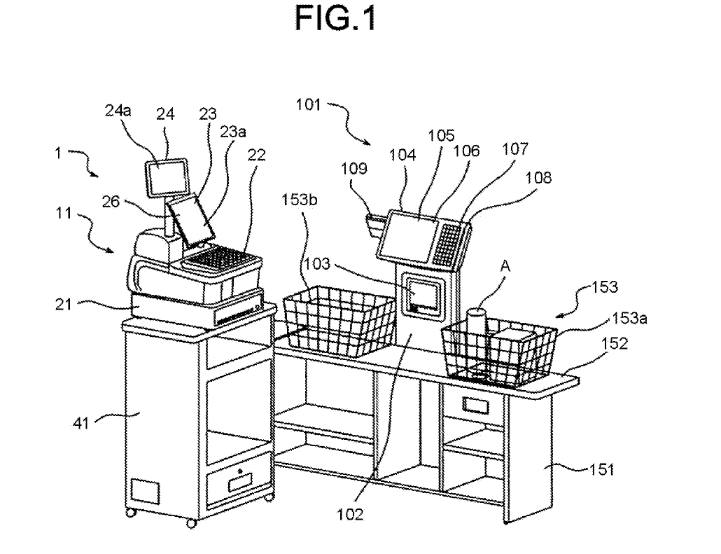

FIG. 1 is a perspective view illustrating an example of a checkout system 1 according to the embodiment. As shown in FIG. 1, the checkout system 1 includes a commodity reading apparatus 101 for reading information relating to a commodity and a POS terminal 11 for registering commodities and carrying out the settlement in one transaction. Hereinafter, an example in which the POS terminal 11 is applied as the information processing apparatus according to the present embodiment is described.

The POS terminal 11 is placed on a drawer 21 on a checkout counter (register table) 41. The drawer 21 is opened or closed under the control of the POS terminal 11. The POS terminal 11 is equipped with a keyboard 22, a display device 23 and a display for customer 24. The keyboard 22 is arranged on the upper surface of the POS terminal 11 for an operator (shop clerk) who operates the POS terminal 11. The display device 23 for displaying information to the operator is arranged at a position opposite to the operator with respect to the keyboard 22. The display device 23 displays information on a display screen 23a thereof. A touch panel 26 is laminated on the display screen 23a. The display for customer 24 is vertically arranged to be rotatable at a backside to the display device 23. The display for customer 24 displays information on a display screen 24a thereof. The display for customer 24 shown in FIG. 1 is in a state in which the display screen 24a thereof faces the operator in FIG. 1, however, the display for customer 24 can be rotated such that the display screen 24a is directed to a customer who stands across a counter table 151 to display information to the customer.

The counter table 151 is formed in horizontally elongated shape along a customer passage and is arranged to be in an L-shape with the checkout counter 41 on which the POS terminal 11 is placed. A commodity receiving surface 152 is formed on the counter table 151. Shopping basket 153 which receives a commodity A therein is placed on the commodity receiving surface 152. It can be understood to classify the shopping basket 153 on the counter table 151 into a first shopping basket 153a brought to the counter table 151 by a customer and a second shopping basket 153b placed facing the first shopping basket 153a across the commodity reading apparatus 101. The shopping basket 153, which is not limited to a so-called basket shape, may be a tray and the like. Further, the shopping basket 153 (second shopping basket 153b), which is not limited to a so-called basket shape, may be a box, a bag and the like.

The commodity reading apparatus 101, which is connected with the POS terminal 11 to be capable of sending and receiving data, is arranged on the commodity receiving surface 152 of the counter table 151. The commodity reading apparatus 101 comprises a thin rectangular housing 102 vertically arranged on the counter table 151. A reading window 103 is arranged at the front side of the housing 102. A display and operation section 104 is installed on the upper portion of the housing 102. A display device 106 serving as a display device on the surface of which a touch panel 105 is laminated is arranged on the display and operation section 104. A keyboard 107 is arranged at the right side of the display device 106. A card scanning slot 108 of a card reader (not shown) is arranged at the right side of the keyboard 107. A display for customer 109 for providing information for a customer is arranged at the left side of the display and operation section 104.

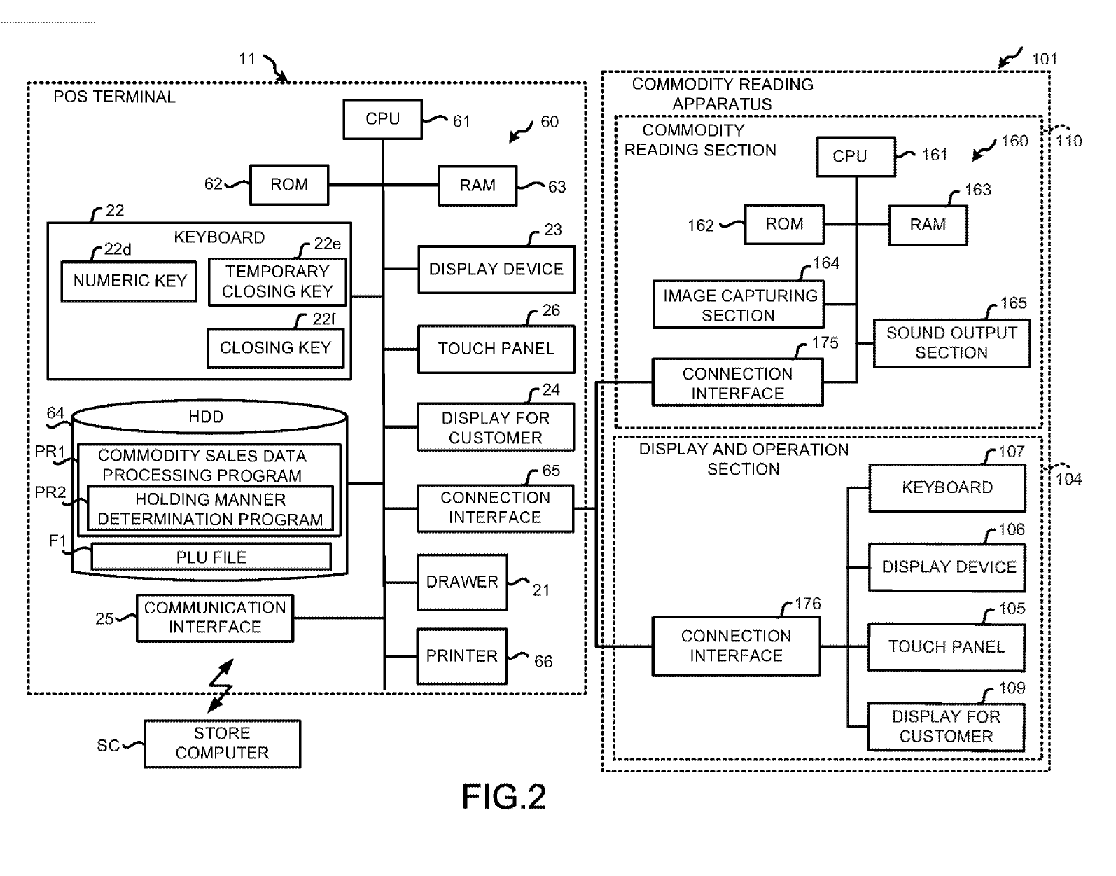

Such a commodity reading apparatus 101 includes a commodity reading section 110 (refer to FIG. 2). The commodity reading section 110 is equipped with an image capturing section 164 (refer to FIG. 2) at the rear side of the reading window 103.

Commodities A purchased in one transaction are put in the first shopping basket 153a and are brought to the counter table 151 by a customer. The commodities A in the first shopping basket 153a are moved one by one to the second shopping basket 153b by the operator who operates the commodity reading apparatus 101. During the movement, the commodity A is directed to the reading window 103 of the commodity reading apparatus 101. At this time, the image capturing section 164 (refer to FIG. 2) arranged in the reading window 103 captures an image of the commodity A through the reading window 103.

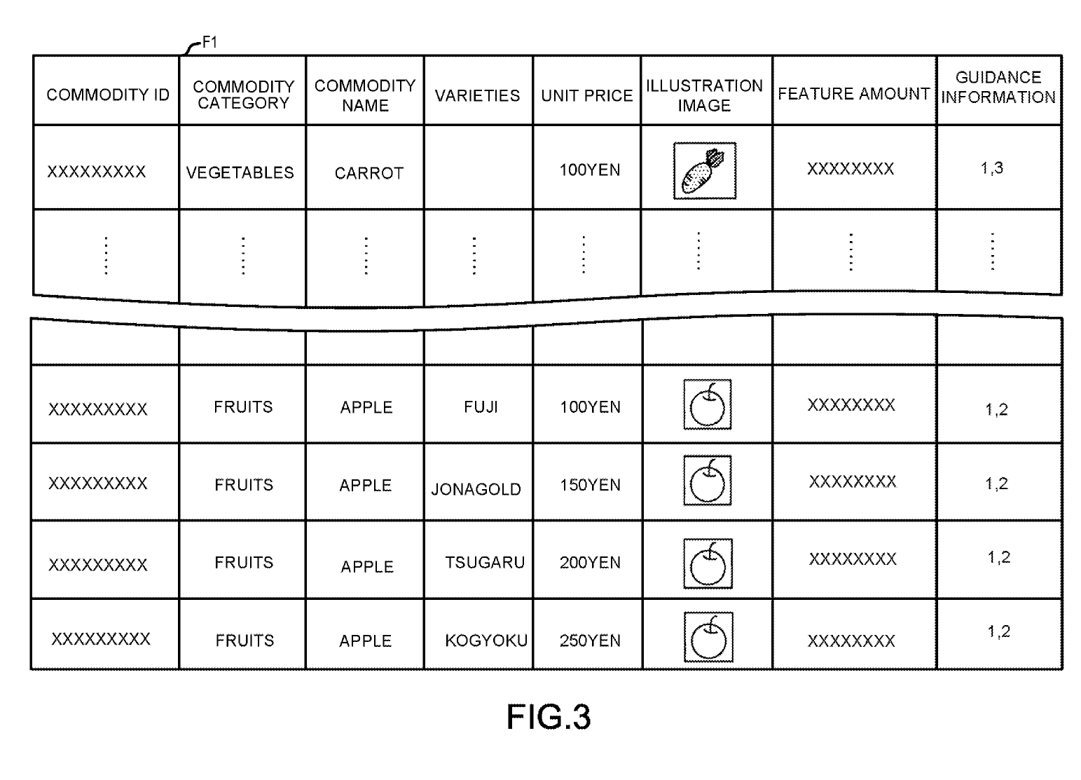

In the commodity reading apparatus 101, a screen for designating a commodity registered in a later-described PLU file F1 (refer to FIG. 3) corresponding to the commodity A contained in an image captured by the image capturing section 164 is displayed on the display and operation section 104, and a commodity ID of the designated commodity is notified to the POS terminal 11. In the POS terminal 11, information relating to the sales registration of the commodity category, commodity name, unit price and the like of the commodity specified with the commodity ID is recorded in a sales master file (not shown) based on the commodity ID notified from the commodity reading apparatus 101 to carry out sales registration.

FIG. 2 is a block diagram illustrating the hardware constitution of the POS terminal 11 and the commodity reading apparatus 101. The POS terminal 11 includes a microcomputer 60 serving as an information processing section for executing information processing. The microcomputer 60 is constituted by connecting a ROM (Read Only Memory) 62 and a RAM (Random Access Memory) 63 with a CPU (Central Processing Unit) 61 which executes various kinds of arithmetic processing to control each section of the POS terminal 11 through a bus line.

The drawer 21, the keyboard 22, the display device 23, the touch panel 26 and the display for customer 24 are all connected with the CPU 61 of the POS terminal 11 via various input/output circuits (none is shown). These sections are controlled by the CPU 61.

The keyboard 22 includes numeric keys 22d on which numeric characters such as ‘1’, ‘2’, ‘3’ . . . and operators such as multiplying operator ‘*’ are displayed, a temporary closing key 22e and a closing key 22f.

A HDD (Hard Disk Drive) 64 is connected with the CPU 61 of the POS terminal 11. The HDD 64 stores programs and various files. When the POS terminal 11 is started, the programs and the various files stored in the HDD 64 are all or partially developed or copied on the RAM 63 to be executed by the CPU 61. The programs stored in the HDD 64 include, for example, a commodity sales data processing program PR1 and a holding manner determination program PR2. The files stored in the HDD 64 include, for example, a PLU file F1 sent from a store computer SC.

The PLU file F1 is a commodity file in which the information relating to the sales registration of the commodity A is stored for each of the commodities A displayed and sold in the store. In the following description, the PLU file F1 is used as a dictionary, however, the dictionary may be a file different from the PLU file F1. The dictionary stores, for a plurality of commodities, the reference data (feature amount) used to recognize the commodity extracted from the image data obtained from a captured image. In a case in which the dictionary is a file different from the PLU file F1, the reference data (feature amount) stored in the dictionary is associated with the information (recognition information) stored in the PLU file F1. The feature amount is obtained by parameterizing the appearance feature such as the standard shape, surface tint, pattern, concave-convex state and the like of the commodity.

FIG. 3 is a conceptual diagram illustrating an example of the data arrangement of the PLU file F1. As shown in FIG. 3, information relating to a commodity such as a commodity ID serving as recognition information uniquely assigned to each commodity A, a commodity category the commodity A belongs to, a commodity name, a variety, a unit price and the like, an illustration image indicating the commodity A, and the feature amount such as the tint, the surface concave-convex state and the like read from the captured commodity image, for each commodity A are stored in the PLU file F1 as the commodity information of the commodity A. Further, the feature amount is the reference data used in the later-described similarity degree determination. The PLU file F1 can be read by the commodity reading apparatus 101 through a later-described connection interface 65.

In addition, as shown in FIG. 3, the PLU file F1 further stores guidance information for each commodity. The guidance information displays the guidance indicating an important point or matters to be attended to for each feature of an object (commodity A) photographed by the image capturing section 164 when the commodity A is held over the image capturing section 164.

For example, the following guidance is given as the guidance display indicating the important point or matters to be attended to for each feature of a commodity to be photographed.

1. Guidance indicating an image capturing distance to the image capturing section 164 commonly applied, for all commodities to be photographed.

2. Guidance guiding to photograph the entire object while turning the object around, for a spherical object such as an apple and the like.

3. Guidance guiding to photograph the entire object to obtain an image in a longitudinal direction of the object while turning the object around by taking the longitudinal direction as an axis, for a long object such as a white radish, leek and the like.

4. Guidance guiding to photograph an object in such a manner that the hand of a shop clerk holding the object is not imaged in an image captured by the image capturing section 164, for a small object such as a citrus sudachi and the like.

1 and 3 are set as the guidance information for an object “carrot” shown at the top of FIG. 3.

Returning to FIG. 2, a communication interface 25 for executing data communication with a store computer SC is connected with the CPU 61 of the POS terminal 11 through the input/output circuit (not shown). The store computer SC is arranged at a back office and the like in a store. The HDD (not shown) of the store computer SC stores the PLU file F1 to be delivered to the POS terminal 11.

The connection interface 65 which enables the data transmission/reception with the commodity reading apparatus 101 is connected with the CPU 61 of the POS terminal 11. The commodity reading apparatus 101 is connected with the connection interface 65. A receipt printer 66 which carries out printing on a receipt and the like is connected with the CPU 61 of the POS terminal 11. The POS terminal 11 prints content of one transaction on a receipt under the control of the CPU 61.

The commodity reading section 110 of the commodity reading apparatus 101 also includes a microcomputer 160. The microcomputer 160 is constituted by connecting a ROM 162 and a RAM 163 with a CPU 161 through a bus line. The ROM 162 stores programs executed by the CPU 161. The image capturing section 164 and a sound output section 165 are connected with the CPU 161 through various input/output circuits (none is shown). The operations of the image capturing section 164 and the sound output section 165 are controlled by the CPU 161. The display and operation section 104 is connected with the commodity reading section 110 and the POS terminal 11 through a connection interface 176. The operation of the display and operation section 104 is controlled by the CPU 161 of the commodity reading section 110 and the CPU 61 of the POS terminal 11.

The image capturing section 164, which is a color CCD image sensor or a color CMOS image sensor and the like, is an image capturing module for carrying out an image capturing processing through the reading window 103 under the control of the CPU 161. For example, images are captured by the image capturing section 164 at 30 fps (Flame Per Second). The frame images (captured images) sequentially captured by the image capturing section 164 at a predetermined frame rate are stored in the RAM 163. That is, the image capturing section 164 photographs the commodity A held by the shop clerk.

The sound output section 165 includes a sound circuit and a speaker and the like for issuing a preset alarm sound and the like. The sound output section 165 gives a notification with a voice or an alarm sound under the control of the CPU 161.

Further, a connection interface 175 which is connected with the connection interface 65 of the POS terminal 11 and enables the data transmission/reception with the POS terminal 11 is connected with the CPU 161. The CPU 161 carries out data transmission/reception with the display and operation section 104 through the connection interface 175.

Next, the functional components of the CPU 61 realized by executing programs (commodity sales data processing program PR1 and holding manner determination program PR2) by the CPU 61 are described below.

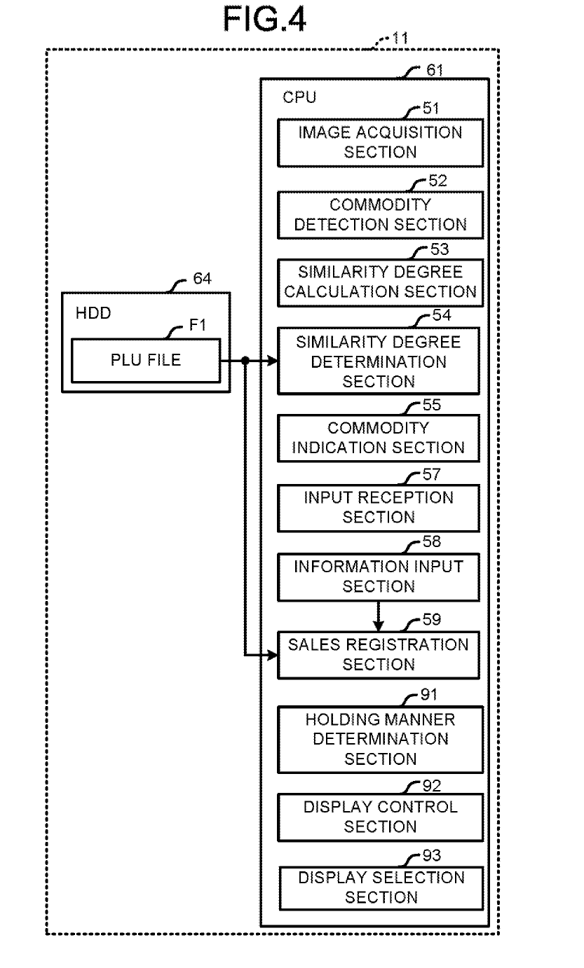

FIG. 4 is a block diagram illustrating the functional components of the POS terminal 11. As shown in FIG. 4, the CPU 61 of the POS terminal 11 executes the commodity sales data processing program PR1 and the holding manner determination program PR2 to function as an image acquisition section 51, a commodity detection section 52, a similarity degree calculation section 53, a similarity degree determination section 54, a commodity indication section 55, an input reception section 57, an information input section 58, a sales registration section 59 serving as a sales registration processing module, a holding manner determination section 91, a display control section 92 and a display selection section 93.

(Commodity Registration Processing and Sales Registration Processing)

First, the commodity registration processing according to the general object recognition by the image acquisition section 51, the commodity detection section 52, the similarity degree calculation section 53, the similarity degree determination section 54, the commodity indication section 55, the input reception section 57 and the information input section 58 of the POS terminal 11 and the sales registration processing by the sales registration section 59 are described schematically.

The image acquisition section 51, functioning as an image acquisition module, outputs an ON-signal of image capturing to the image capturing section 164 to enable the image capturing section 164 to start an image capturing operation. The image acquisition section 51 sequentially acquires the frame images which are captured and stored in the RAM 163 by the image capturing section 164 after the image capturing operation is started. The image acquisition section 51 acquires the frame images from the RAM 163 in the order the same as that of storing them to the RAM 163.

The commodity detection section 52, functioning as a detection module, detects the commodity A contained in the frame image, which is captured by the image capturing section 164 and acquired by the image acquisition section 51, to extract the feature amount thereof. The commodity detection section 52 detects the whole or part of the commodity A contained in the frame image through a pattern matching technology to extract the feature amount of the photographed commodity A. Specifically, the commodity detection section 52 extracts a contour line and the like from the binary image of the acquired frame image. Next, the contour line extracted from the last time frame image is compared with the contour line extracted from the this time frame image to detect the commodity A which is held over the reading window 103 for the sales registration.

As another method for detecting a commodity A, it is detected whether or not there is a flesh color area in the acquired frame image. If the flesh color area is detected, in other words, if the hand of a shop clerk (operator) is detected, the aforementioned detection of the contour line nearby the flesh color area is carried out to try to extract the contour line of the commodity that is assumed to be held by the shop clerk. At this time, if a contour line representing the shape of a hand and the contour line of another object nearby the contour line of the hand are detected, the commodity detection section 52 detects the commodity A from the contour line of the object.

Further, the commodity detection section 52 reads the surface state such as the tint, the surface concave-convex state and the like of the commodity A from the whole or part of the image of the detected commodity A as the feature amount thereof. In addition, to shorten the processing time, the commodity detection section 52 does not take the contour or the size of the commodity A into consideration.

The similarity degree calculation section 53 respectively compares the feature amount indicating the surface state such as the tint, the surface concave-convex state and the like of the commodity image of each commodity (hereinafter referred to as a “registered commodity”) registered in the PLU file F1 with the feature amount of the commodity A extracted by the commodity detection section 52 to calculate a similarity degree between the commodity A and the registered commodity in the PLU file F1. Herein, in a case in which the commodity image at the time of commodity registration of each commodity stored in the PLU file F1 is set to “similarity degree:1.0”=1000, the similarity degree indicates how similar the whole or part of the image of the commodity A is to the registered commodity image. For example, in the tint and the surface concave-convex state, the weightings on them are respectively changed to calculate the similarity degree.

The recognition of an object contained in an image as stated above is referred to as general object recognition. As to the general object recognition, various recognition technologies are described in the following document.

Keiji Yanai “Present situation and future of generic object recognition”, Journal of Information Processing Society, Vol. 48, No. SIG16 [Search on Heisei 22 August 10th], Internet<URL: http://mm.cs.uec.ac.jp/IPSJ-TCVIM-Yanai.pdf>

In addition, the technology carrying out the general object recognition by performing an area-division on the image for each object is described in the following document.

Jamie Shotton etc, “Semantic Texton Forests for Image Categorization and Segmentation”, [Search on Heisei 22 August 10th], Internet<URL: http://cite seerx.ist.psu.edu/viewdoc/download?doi=10.1.1.145.3036&rep=rep1&type=pdf>

It is noted that no limitation is given to the method for calculating the similarity degree between the image of the photographed commodity A and the registered commodity in the PLU file F1. For example, the similarity degree between the image of the photographed commodity A and each registered commodity in the PLU file F1 can be calculated as an absolute evaluation or a relative evaluation.

If the similarity degree is calculated as an absolute evaluation, the image of the photographed commodity A and each registered commodity in the PLU file F1 are compared one by one, and the similarity degree obtained from the comparison result can be adopted as it is. In a case in which the similarity degree is calculated as a relative evaluation, if five commodities (commodities AA, AB, AC, AD and AE) are registered in the PLU file F1, the similarity degree is obtained as long as the sum of the similarity degrees between the photographed commodity A and each registered commodity becomes 1.0 (100%); for example, the similarity degree between the photographed commodity A and the commodity AA is 0.6, the similarity degree between the photographed commodity A and the commodity AB is 0.1, the similarity degree between the photographed commodity A and the commodity AC is 0.1, the similarity degree between the photographed commodity A and the commodity AD is 0.1, and the similarity degree between the photographed commodity A and the commodity AE is 0.1.

The similarity degree determination section 54 compares the similarity degrees between the image of the commodity A and the registered commodities in the PLU file F1 for each frame image acquired by the image acquisition section 51. In the present embodiment, a plurality of conditions are set in stages for the similarity degrees between the image of the commodity A and the images of the registered commodities, and the similarity degree determination section 54 determines the registered commodity or selects a candidate of the commodity according to the condition that is met. No specific limitation is given to the conditions relating to the similarity degree, and a case in which conditions a-d are used is described below.

Herein, the condition a and the condition b, which are a first condition according to the present embodiment, are used to determine the commodity A photographed by the image capturing section 164 as one commodity within the registered commodities in the PLU file F1. The condition c, which is a second condition according to the present embodiment, is used to extract candidates of the commodity A photographed by the image capturing section 164 in a case in which there is no multiple objects of different varieties belonging to the same commodity category within the registered commodities in the PLU file F1. The condition d, which is a third condition according to the present embodiment, is used to extract a candidate of the commodity A photographed by the image capturing section 164 in a case in which there are multiple objects of different varieties belonging to the same commodity category within the candidates of the commodity A meeting the condition c.

The similarity degree determination section 54 determines (confirms) that the registered commodity meeting the condition a or the condition b is a commodity (hereinafter referred to as a “determined commodity”) corresponding one-to-one to the commodity A photographed by the image capturing section 164. The similarity degree determination section 54 determines that the registered commodity meeting the condition c is not a determined commodity but a candidate (hereinafter referred to as a “commodity candidate”) of the commodity A photographed by the image capturing section 164. Then the registered commodity meeting the condition c is extracted from the plurality of registered commodities in the PLU file F1 to extract the commodity candidate of the commodity A.

Further, the similarity degree determination section 54 determines that the registered commodities (objects of different varieties belonging to the same commodity category) meeting the condition d are not the determined commodity but the candidates of the commodity A photographed by the image capturing section 164. Then the registered commodities meeting the condition d are extracted from the plurality of registered commodities in the PLU file F1 to extract the commodity candidates of the commodity A.

No specific limitation is given to the details of the conditions a-c as long as the conditions are set in stages respectively corresponding to the similarity degrees. For example, the conditions a-c may be set according to a plurality of preset threshold values. Herein, it is exemplified that the conditions a-c are set according to a first threshold value-third threshold value. In addition, the first-third threshold values meet the following relation: first threshold value>second threshold value>third threshold value.

The similarity degree determination section 54 counts the number of times the similarity degree between the commodity A and the registered commodity is greater than the predetermined first threshold value (for example, 90%), and determines that the condition a is met if the number of times is greater than a predetermined number of times. In a case in which the first threshold value is set high enough so that no error determination occurs, the predetermined number of times may be set to one to determine whether or not the condition a is met.

The similarity degree determination section 54 determines that the condition b is met if the similarity degree between the commodity A and the registered commodity is smaller than the first threshold value (for example, 90%) and greater than the second threshold value (for example, 75%) which is smaller than the first threshold value. It is determined that the registered commodity meeting the condition b is a determined commodity, but it needs to be confirmed by an operator. Further, it is also applicable to count the number of times the similarity degree between the commodity A and the registered commodity is smaller than the first threshold value (for example, 90%) and greater than the second threshold value (for example, 75%) smaller than the first threshold value, and determine that the condition b is met if the number of times counted is greater than a predetermined number of times.

The similarity degree determination section 54 determines that the condition c is met if the similarity degree between the commodity A and the registered commodity is smaller than the second threshold value (for example, 75%) and greater than the third threshold value (for example, 10%) which is smaller than the second threshold value. Further, it is also applicable to count the number of times the similarity degree between the commodity A and the registered commodity is smaller than the second threshold value (for example, 75%) and greater than the third threshold value (for example, 10%) smaller than the second threshold value, and determine that the condition c is met if the number of times counted is greater than a predetermined number of times.

Each of the conditions a-c, which is not limited to the example described above, may be properly set according to the magnitude of the similarity degree, the number of determination times and the like. The predetermined number of times used in the determination of the conditions a -c may be set to be different for each condition.

In a case in which there are a plurality of objects of different varieties belonging to the same commodity category within the registered commodities meeting the condition c, the similarity degree determination section 54 sums the similarity degrees of the plurality of the different varieties, and determines that the condition d is met if the sum of the similarity degrees of the different varieties in the same commodity category is greater than the predetermined second threshold value (for example, 75%).

The commodity indication section 55 notifies, through an image output or sound output and the like, the operator or the customer that it is uniquely confirmed that the commodity photographed by the image capturing section 164 is the registered commodity meeting the condition a or the condition b.

The information input section 58 inputs information (for example, the commodity ID, the commodity name and the like) indicating the commodity A determined in the aforementioned manner through the connection interface 175.

The information input section 58 may also input the sales volume, which is separately input through the touch panel 105 or the keyboard 107, together with the commodity ID and the like.

The sales registration section 59 carries out the sales registration of the commodity A specified with the commodity ID, using the commodity ID and the sales volume input from the information input section 58. Specifically, the sales registration section 59 records the notified commodity ID and the commodity category, commodity name and unit price specified with the commodity ID in a sales master file together with the sales volume referring to the PLU file F1 to carry out the sales registration.

(Holding Manner Determination Processing on Object Recognition)

Next, the holding manner determination processing on the object recognition carried out through the image acquisition section 51, the commodity detection section 52, the similarity degree calculation section 53, the similarity degree determination section 54, the holding manner determination section 91, the display control section 92 and the display selection section 93 of the POS terminal 11 is described.

As stated above, the POS terminal 11 adopts the general object recognition in which the category and the like of a target object is recognized (detected) according to the similarity degree obtained by comparing the feature amount of the object extracted from the image data obtained from an image captured by the image capturing section 164 with prepared reference data (feature amount) in the PLU file F1 serving as a dictionary.

In the general object recognition, the image data obtained from a captured image varies according to the holding manner of the commodity A. Thus, if the commodity A is not held in a suitable manner, the commodity A cannot be recognized and too much time is taken for the commodity registration.

Thus, the POS terminal 11 according to the present embodiment is capable of displaying the propriety of the holding manner of the commodity A in the object recognition. That is, the CPU 61 of the POS terminal 11 executes the holding manner determination program PR2 to function as the image acquisition section 51, the commodity detection section 52, the similarity degree calculation section 53, the similarity degree determination section 54, the holding manner determination section 91, the display control section 92 and the display selection section 93, as shown in FIG. 4. Hereinafter, each section in the holding manner determination processing on the object recognition is described.

First, similar to the commodity registration processing, the image acquisition section 51 acquires the frame image captured by the image capturing section 164. Then, similar to the commodity registration processing, the commodity detection section 52, the similarity degree calculation section 53 and the similarity degree determination section 54 recognize the commodity A contained in the image acquired by the image acquisition section 51.

The holding manner determination section 91, functioning as a determination module, determines whether or not the commodity A detected by the commodity detection section 52 is held over the image capturing section 164 in a proper holding manner.

First, an improper holding manner is described. Several representative examples of the improper holding manner are listed as follows.
(1) A case in which an object is detected but the commodity A cannot be recognized due to improper position and size.

(2) A case in which an object is detected but the commodity A cannot be recognized because the hand holding the commodity A shields the commodity A.

(3) A case in which an object is detected and recognized, but as a result, the object is not a commodity registration target.

The determination processing of the improper holding manner recorded in (1) is described. As to the propriety of the position of the object, the holding manner determination section 91 calculates the center point of the detected object. Sequentially, the holding manner determination section 91 determines whether or not the coordinate of the center point of the object is nearby the center of the frame image. If the coordinate of the object center point is not nearby the center, the holding manner determination section 91 determines that the position of the object is improper. In a case in which the size is improper, for example, in a case in which the object is positioned at a position far away from the image capturing section 164 and the object in the captured frame image is small, the holding manner determination section 91 determines that the holding manner is improper.

The determination processing of the improper holding manner recorded in (2) is described. In a case in which the proportion of the hand holding the object against the object photographed in the frame image is greater than a specific value, the holding manner determination section 91 determines that the holding manner is improper.

The determination processing of the improper holding manner recorded in (3) is described. In a case of an object other than a preset commodity registration target, the holding manner determination section 91 determines that the holding manner is improper. Specifically, in a case of a fruits cap which covers the fruits to protect the fruits from impact. That is, it is supposed to hold the object over the image capturing section 164 with the fruits cap taken off, however, the object is held over the image capturing section 164 in state of being covered by the fruits cap, thus, it is determined that the holding manner is improper.

Next, a case in which the holding manner determination section 91 determines that the holding manner is proper is described. Several representative examples of the proper holding manner are listed as follows.

(1) A case in which an object is detected and is determined, by the similarity degree determination section 54, to be a determined commodity.

(2) A case in which an object is detected and is determined, by the similarity degree determination section 54, to be a commodity candidate.

(3) A case in which an object is detected and commodity recognition is carried out, but there is no registered commodity serving as a candidate.

The determination processing of the proper holding manner recorded in (1) is described. In a case in which an object is detected by the commodity detection section 52 and the detected object is determined to be a determined commodity by the similarity degree determination section 54, the holding manner determination section 91 determines that the holding manner is proper.

The determination processing of the proper holding manner recorded in (2) is described. In a case in which an object is detected by the commodity detection section 52 and the detected object is determined to be a commodity candidate by the similarity degree determination section 54, the holding manner determination section 91 determines that the holding manner is proper.

The determination processing of the proper holding manner recorded in (3) is described. In a case in which an object is detected by the commodity detection section 52 and the detected object is subject to commodity recognition, but as a result, there is no registered commodity serving as a candidate, the holding manner determination section 91 determines that the holding manner is proper. Specifically, a case in which the similarity degree determination section 54 determines that there is no commodity candidate. Though the object cannot be recognized, the holding manner itself is proper, thus, the holding manner determination section 91 determines that the holding manner is proper.

The display control section 92, functioning as a display control module, controls to display the frame image captured by the image capturing section 164 and acquired by the image acquisition section 51 on the display device 106. At this time, the display control section 92 displays the propriety of the holding manner determined by the holding manner determination section 91 over the frame image. Specifically, the display control section 92 displays frame borders of different types on the display device 106 over the frame image according to the determination result as the propriety of the holding manner determined by the holding manner determination section 91.

At this time, the display control section 92 displays a frame border surrounding the outer diameter of the object specified as a target to be recognized within the objects contained in the frame image. In this way, the operator can be aware of the object to be subject to the general object recognition.

For example, the display control section 92 displays a blue frame border in a case in which the holding manner determination section 91 determines that the holding manner is proper, and displays a red frame border in a case in which the holding manner determination section 91 determines that the holding manner is improper. In this way, the operator can look at the display device 106 to be aware of the propriety of the holding manner of the commodity A held over the image capturing section 164. As to the display manner of the frame border, any frame border can be selected by the display selection section 93.

The display selection section 93, functioning as a selection module, selects the display manner of the frame border to be displayed by the display control section 92. Specifically, the display selection section 93 selects any line from a plurality of types of predetermined lines. At this time, the display selection section 93 respectively selects two types of frame borders, that is, the frame border indicating a proper holding manner and a frame border indicating an improper holding manner. As to the types of the lines, for example, solid line, dashed line, dotted line, chain line, double line, thick line, thin line and the like are listed.

Further, the display selection section 93 can select any color for the frame border. At this time, the display selection section 93 also respectively selects two types of frame borders in different colors, that is, the frame border indicating a proper holding manner and a frame border indicating an improper holding manner. As to the designation method of color, the color can be designated by designating RGB values. The RGB values indicate the amount of each of red, green and blue colors, and in this way, various colors can be designated. The display selection section 93 can designate each of the red, green and blue colors of the RGB values to values from 0 to 255. As to the designation of color, it is preferred to designate complementary colors located at the opposite positions in hue ring. In this way, the operator can recognize the difference easily.

Specifically, it is preferred to set the frame border indicating a proper holding manner to a blue color (RGB values: 115, 219 and 254) and set the frame border indicating an improper holding manner to a red color (RGB values: 255, 111 and 32). As shown by the RGB values, if a yellow element is added, the recognition becomes easier even for an operator who finds it difficult to recognize color.

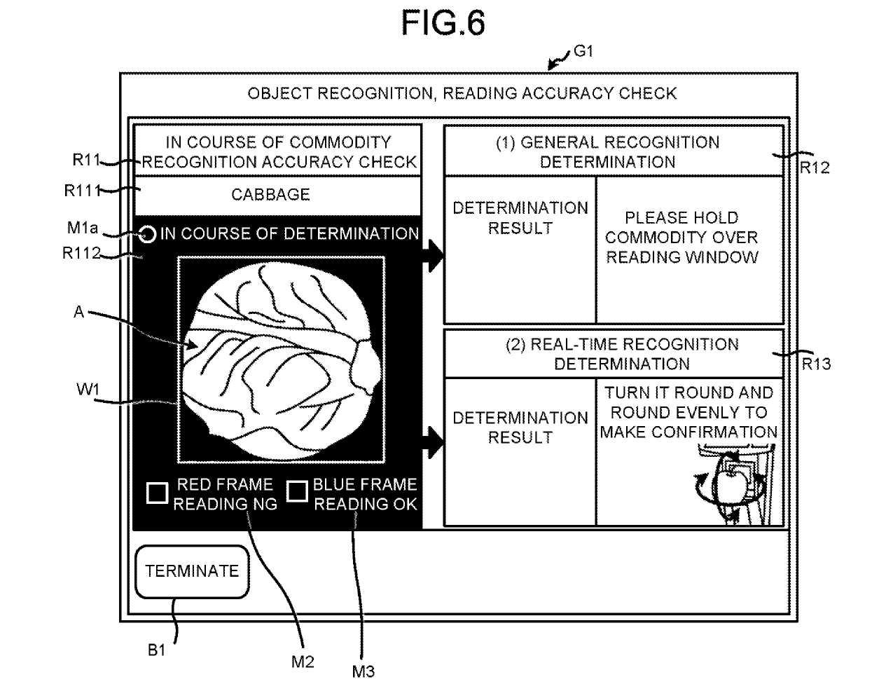

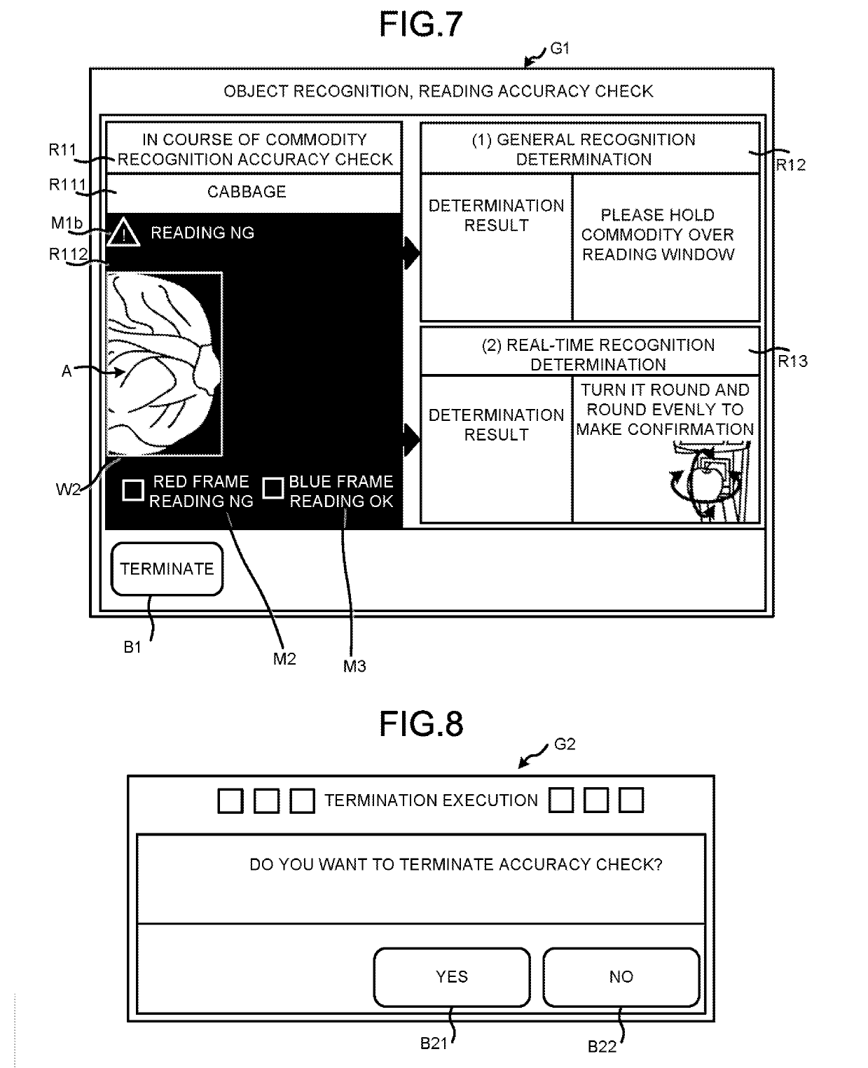

The display selection section 93 can select the shape of the frame border freely. The shape of the frame border refers to the shape of the frame border displayed surrounding the outer diameter of the object specified as a target to be recognized. It is exemplified in later-described FIG. 6 and FIG. 7 that the shape of frame borders W1 and W2 is rectangular, however, the shape of the frame borders is not limited to this. Specifically, as to the shape of the frame borders, circle such as oval, oblong, ellipse and the like and polygon such as triangle, pentagon, hexagon and the like can be listed.

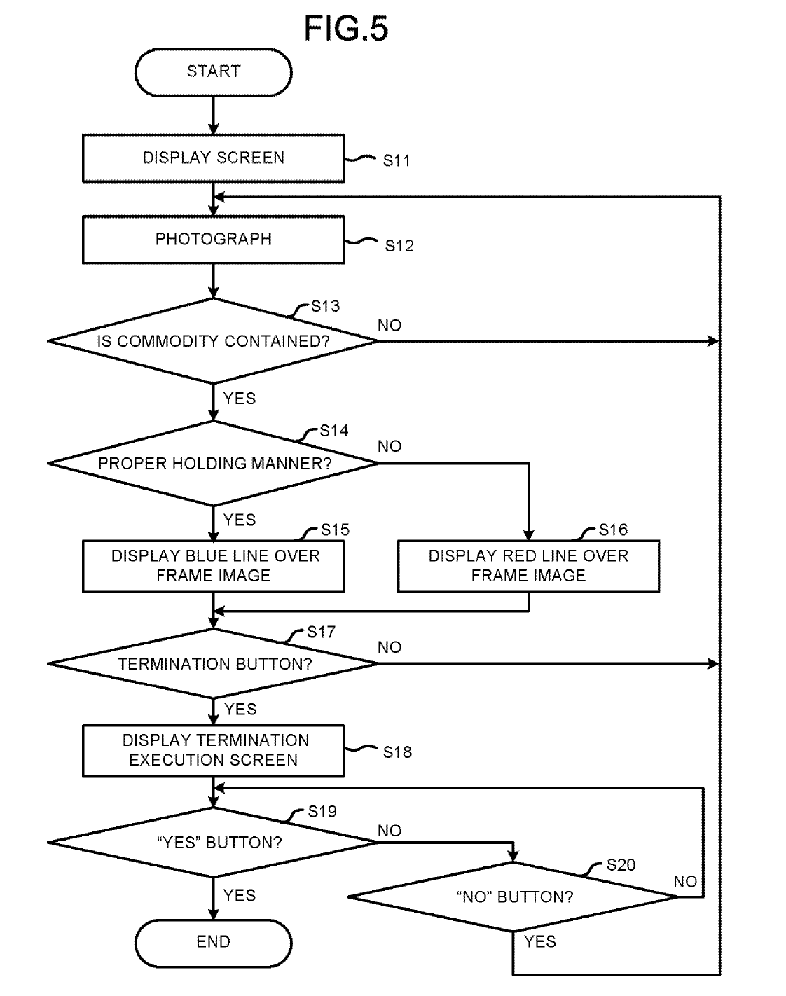

Next, the operation of the checkout system 1 in the holding manner determination processing is described in detail. FIG. 5 is a flowchart illustrating a holding manner determination processing executed by the checkout system 1.

The flowchart shown in FIG. 5 indicates a screen in an accuracy check processing for confirming the accuracy of the reference data (feature amount) stored in the aforementioned dictionary. However, the holding manner determination processing can be applied to all the processing in which the commodity A is held. For example, the holding manner determination processing can be applied to commodity registration processing (recognition processing), a processing (learning processing) for registering the reference data (feature amount) in the dictionary, and the like.

First, the CPU 61 of the POS terminal 11 displays an accuracy check screen G1 (refer to FIG. 6 and FIG. 7) (ACT S11). Next, the CPU 61 of the POS terminal 11 photographs the commodity A with the image capturing section 164 (ACT S12).

Then the CPU 61 of the POS terminal 11 (commodity detection section 52) determines whether or not the commodity A can be detected from the frame image (ACT S13). If the commodity A cannot be detected from the frame image (NO in ACT S13), the CPU 61 of the POS terminal 11 (commodity detection section 52) executes the processing in ACT S12 again.

On the other hand, if the commodity A is detected from the frame image (YES in ACT S13), the CPU 61 of the POS terminal 11 (holding manner determination section 91) determines whether or not the holding manner of the commodity A contained in the frame image is proper ACT S14).

If the holding manner is proper (YES in ACT S14), the CPU 61 of the POS terminal 11 (display control section 92) displays the accuracy check screen G1 on which the frame border indicating the proper holding manner is displayed over the frame image (ACT S15).

FIG. 6 is a diagram illustrating an example of the accuracy check screen G1 on which the frame border indicating the proper holding manner is displayed over the frame image. The accuracy check screen G1 includes, if roughly classified, a commodity display area R11, a general recognition determination area R12, a real-time recognition determination area R13 and a terminate button B1.

The commodity display area R11 is an area for displaying an image which is obtained by the image capturing section 164 by photographing a target commodity of the holding manner determination processing and acquired by the image acquisition section 51. The commodity display area R11 includes a commodity name area R111 and an image capturing area R112. The commodity name area R111 displays the commodity name of a preselected target commodity to be subject to the holding manner determination processing. The image capturing area R112 displays the image of the commodity A photographed by the image capturing section 164. The image capturing area R112 further displays the propriety of the holding manner serving as the determination result of the holding manner determination section 91 over the frame image.

That is, the image capturing area R112 includes the commodity A, the frame border W1, a state message M1a, a proper display description M2 and an improper display description M3. The commodity A is the commodity A to be photographed. In FIG. 6, a cabbage is displayed as the commodity A. The frame border W1 is a rectangular frame border displayed surrounding the outer diameter of the commodity A specified as a recognition target. In FIG. 6, a blue frame border is displayed surrounding the outer diameter of the cabbage to indicate a proper holding manner. The state message M1a indicates the current processing state. In FIG. 6, a message “in course of determination” indicating that the commodity A is being recognized is displayed. The proper display description M2 is a message which describes the frame border displayed in a case of a proper holding manner. The improper display description M3 is a message which describes the frame border displayed in a case of an improper holding manner.

The general recognition determination area R12 displays a determination result of a commodity recognition accuracy check function for checking the accuracy of the reference data (similarity degree). The real-time recognition determination area R13 displays a recognition result of a single frame so that the recognition result is displayed in real time. The real-time recognition determination area R13 displays guidance information indicating the important point or matters to be attended to for each feature of the photographed commodity. In FIG. 6, a message “turn it round and round evenly to make confirmation” is displayed as the guidance information. The terminate button B1 is pressed if the operator desires to terminate the accuracy check processing.

On the other hand, in a case of an improper holding manner (NO in ACT S14), the CPU 61 of the POS terminal 11 (display control section 92) displays the accuracy check screen G1 on which the frame border indicating the improper holding manner is displayed over the frame image (ACT S16).

FIG. 7 is a diagram illustrating an example of the accuracy check screen G1 on which the frame border indicating the improper holding manner is displayed over the frame image. In FIG. 7, the frame border W2 indicating the improper holding manner is displayed over the frame image because the coordinate of the center point of the commodity A is at the left side of the frame image. That is, FIG. 7 displays the state message M1b and the frame border W2, which are different from the state message M1a and the frame border W1 shown in FIG. 6.

Specifically, as the holding manner is improper, a message “reading NG” is displayed as the state message M1b to indicate that the commodity A cannot be recognized. The frame border W2 is a rectangular frame border displayed surrounding the outer diameter of the commodity A. In FIG. 7, a red frame border is displayed surrounding the outer diameter of the cabbage to indicate an improper holding manner.

Next, the CPU 61 of the POS terminal 11 determines whether or not the terminate button B1 displayed on the accuracy check screen G1 is pressed (ACT S17). If the terminate button B1 is not pressed (NO in ACT S17), the CPU 61 of the POS terminal 11 executes the processing in ACT S12 again. On the other hand, if the terminate button B1 is pressed (YES in ACT S17), the CPU 61 of the POS terminal 11 displays a termination execution screen G2 (ACT S18).

FIG. 8 is a diagram illustrating an example of the termination execution screen G2. The termination execution screen G2 is used to confirm whether or not the accuracy check processing is to be terminated if the terminate button B1 is pressed. Thus, the termination execution screen G2 displays a message “do you want to terminate accuracy check?” The termination execution screen G2 includes a “YES” button B21 and a “NO” button B22. The “YES” button B21 is pressed if the operator desires to terminate the accuracy check processing. The “NO” button B22 is pressed if the operator desires to cancel the termination of the accuracy check processing.

Next, the CPU 61 of the POS terminal 11 determines whether or not the “YES” button B21 displayed on the termination execution screen G2 is pressed (ACT S19). If the “YES” button B21 is not pressed (NO in ACT S19), the CPU 61 of the POS terminal 11 determines whether or not the “NO” button B22 displayed on the termination execution screen G2 is pressed (ACT S20).

If the “NO” button B22 is not pressed (NO in ACT S20), the CPU 61 of the POS terminal 11 executes the processing in ACT S19 again. On the other hand, if the “NO” button B22 is pressed (YES in ACT S20), the CPU 61 of the POS terminal 11 executes the processing in ACT S12 again

On the other hand, if the “YES” button B21 displayed on the termination execution screen G2 is pressed (YES in ACT S19), the CPU 61 of the POS terminal 11 terminates the accuracy check processing.

As stated above, in accordance with the present embodiment, the image captured by the image capturing section 164 which photographs the commodity A held to the image capturing section 164 is acquired by the image acquisition section 51. The commodity A contained in the image is detected by the commodity detection section 52. The holding manner determination section 91 determines the propriety of the holding manner of the detected commodity A, and the display control section 92 displays the propriety of the holding manner on the display device 106. In this way, the user can do the work while confirming the propriety of the holding manner of the commodity A.

While certain embodiments have been described, these embodiments have been presented by way of example only, and are not intended to limit the scope of the present invention. Indeed, the novel embodiments may be embodied in a variety of other forms; furthermore, various omissions, substitutions and variations thereof may be devised without departing from the spirit of the present invention. The accompanying claims and their equivalents are intended to cover such forms and modifications as would fall within the scope and spirit of the present invention.

Further, it is exemplified in the embodiment described above that the POS terminal 11 is described as an example of the information processing apparatus. However, the information processing apparatus is not limited to the POS terminal 11. For example, the information processing apparatus may be a personal computer, a tablet terminal and the like. In this case, an image capturing device such as a scanner and the like connected with the personal computer or the tablet terminal is required to capture the image of a commodity.

It is exemplified in the embodiment described above that the CPU 61 of the POS terminal 11 serving as the information processing apparatus has functions of the image acquisition section 51, the commodity detection section 52, the similarity degree calculation section 53, the similarity degree determination section 54, the commodity indication section 55, the input reception section 57, the information input section 58, the sales registration section 59, the holding manner determination section 91, the display control section 92 and the display selection section 93. However, these functions may be included in a device other than the CPU 61 of the POS terminal 11. For example, all or part of these functions may be included in the CPU 161 of the commodity reading apparatus 101.

It is exemplified in the embodiment described above that the reference data is described as the feature amount, however, the reference data may be a captured commodity image (reference image).

Further, in the embodiment stated above, the present invention is applied to the checkout system 1 consisting of the POS terminal 11 and the commodity reading apparatus 101 as a store system, however, it is not limited to this, and it may also be applied to a single apparatus comprising all the functions of the POS terminal 11 and the commodity reading apparatus 101. As an apparatus comprising all the functions of the POS terminal 11 and the commodity reading apparatus 101, a self-checkout POS terminal (hereinafter referred to as a self-checkout POS) installed in a store such as a supermarket and the like is known.

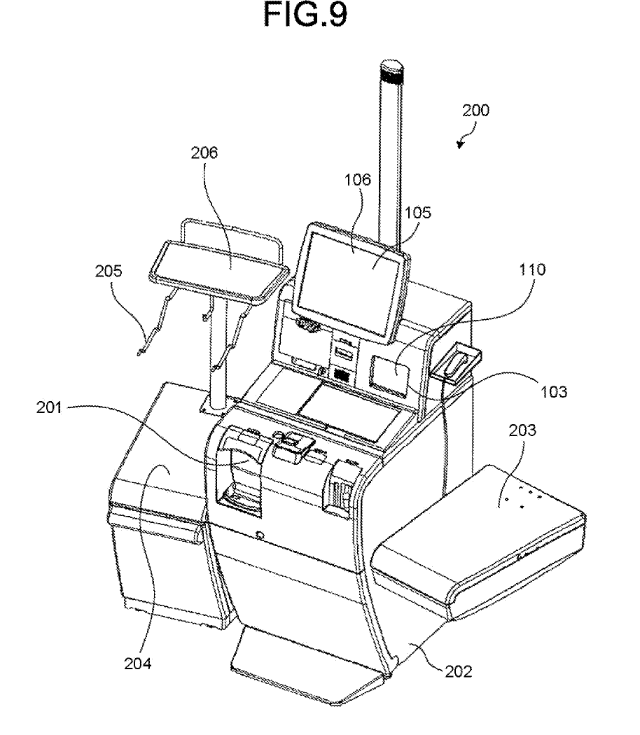

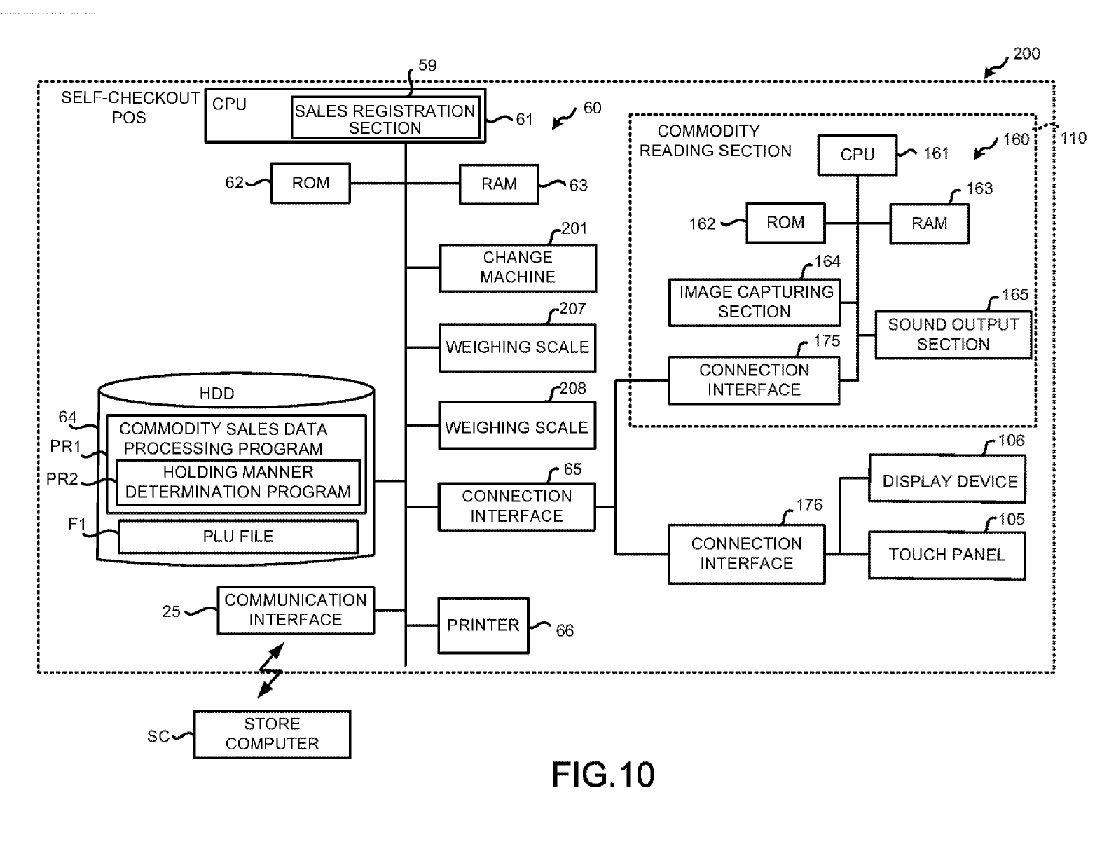

FIG. 9 is a perspective view illustrating the external constitution of the self-checkout POS 200, and FIG. 10 is a block diagram illustrating the hardware constitution of the self-checkout POS 200. Hereinafter, the same numerals are applied to the components similar to that in FIG. 1 and FIG. 2, and therefore the detailed descriptions thereof are not repeated. As shown in FIG. 9 and FIG. 10, self-checkout POS 200 comprises a display device 106 having a touch panel 105 on the surface thereof and a commodity reading section 110 which captures a commodity image to recognize (detect) the category of the commodity A in a main body 202 thereof.

The display device 106 may be, for example, a liquid crystal display. The display device 106 displays a guidance screen for providing customers with a guidance for the operation of the self-checkout POS 200, various input screens, a registration screen for displaying the commodity information captured by the commodity reading section 110, and a settlement screen on which a total amount of the commodities A, a deposit amount, a change amount, and various payment methods are displayed to select a desired payment method.

The commodity reading section 110 captures a commodity image through the image capturing section 164 when the customer holds the code symbol attached to the commodity A over the reading window 103 of the commodity reading section 110.

Further, the self-checkout POS 200 includes a commodity placing table 203 for placing a shopping basket (unsettled basket) in which an unsettled commodity A is put at the right side of the main body 202, and another commodity placing table 204 for placing a shopping basket (settled basket) in which a settled commodity A is put after the sales registration thereof is executed at the left side of the main body 202. A bag hook 205 for hooking a bag for placing the settled commodities A therein and a temporary placing table 206 for placing the settled commodities A temporarily before the settled commodities A are put into a bag are also provided at the left side of the main body 202. The commodity placing tables 203 and 204 are equipped with weighing scales 207 and 208 respectively, and are therefore capable of confirming whether or not the weight of commodity A (commodity taken out of the unsettled basket and commodity put into the settled basket) is the same before and after a settlement of the commodity is executed.

Further, a change machine 201 for receiving bill for settlement and discharging bill as change is arranged in the main body 202 of the self-checkout POS 200.

In a case in which the self-checkout POS 200 having such constitutions as described above is applied to the store system, the self-checkout POS 200 functions as an information processing apparatus.

Further, in the embodiment above, the programs executed by each apparatus are pre-installed in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via an LAN or the Internet.

In addition, the programs executed by each apparatus described in the embodiment above may be stored in a computer connected with a network such as the Internet to be provided through a network download or distributed via a network such as the Internet.

What is claimed is:

1. An information processing apparatus comprising:
an image acquisition module configured to acquire an image captured by an image capturing section which photographs an object held to the image capturing section;
a detection module configured to detect the object contained in the image acquired by the image acquisition module;
a determination module configured to determine the propriety of a holding manner of the object detected by the detection module; and
a display control module configured to control to display the image and the propriety of the holding manner determined by the determination module on a display section over the image.

2. The information processing apparatus according to claim 1, wherein
the display control module controls to display frame borders of different types, which specify the object contained in the image, on the display section according to the determination result as the propriety of the holding manner determined by the determination module.

3. The information processing apparatus according to claim 2, further comprising:
a selection module configured to select a display manner of the frame border displayed as the propriety of the holding manner determined by the determination module.

4. The information processing apparatus according to claim 3, wherein
the selection module selects any one from at least one of colors, shapes and types of lines as the display manner of the frame border.

5. A store system comprising:
an image acquisition module configured to acquire an image captured by an image capturing section which photographs an object held to the image capturing section;
a detection module configured to detect the object contained in the image acquired by the image acquisition module;
a determination module configured to determine the propriety of a holding manner of the object detected by the detection module;
a display control module configured to control to display the image and the propriety of the holding manner determined by the determination module on a display section over the image; and
a sales registration module configured to recognize a commodity photographed by the image capturing section with feature amount which is used for recognizing the object, and execute sales registration processing.

6. A method for recognizing an object by an information processing apparatus, including:
acquiring an image captured by an image capturing section which photographs an object held to the image capturing section;
detecting the object contained in the image acquired by the image acquisition module;
determining the propriety of a holding manner of the object detected by the detection module; and
controlling to display the image and the propriety of the holding manner determined by the determination module on a display section over the image.
